(19) United States
(12) Patent Application Publication
(10) Pub. No.: US 2009/0183814 A1
(43) Pub. Date: Jul. 23, 2009

(54) Pneumatic Tire

(75) Inventors: Ryuichi UEDA, Osaka-fu (JP); Yoshihiro TANAKA, Osaka-fu (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka-fu (JP)

(21) Appl. No.: 12/334,645

(22) Filed: Dec. 15, 2008

(30) Foreign Application Priority Data
Jan. 23, 2008 (JP) 2008-12909

(51) Int. Cl. B60C 9/18

(52) U.S. Cl. 152/527

(57) ABSTRACT

W is the width of the belt layer 5a in the innermost side in the tire radius direction. A is the region of the belt reinforcing layer 11 which is the region at the both sides of the tire equator plane 30 in the tire width direction. B is the region in the outer side of the region A in the tire width direction. C is the region that is further outer side of the region B. Ma, Mb and Mc are tensile modulus per inch of the region A, B and C respectively. The width Wa of the region A is 2 to 10% of W, the width Wb of the region B is 15 to 40% of W, Mc is 350 to 2000N, Ma is 100 to 400% of Mc, Mb is 200 to 800% of Mc, and Mb is larger than Ma.

### CROSS-REFERENCE TO RELATED APPLICATION

This application claims the benefit of priority based on Japanese Patent Application No.2008-012909, the entire same contents of which are incorporated by reference herein.

### BACKGROUND OF THE INVENTION

1. Field of the Invention

The present invention relates to a pneumatic tire and in more detail, the present invention relates to the pneumatic radial tire with improved handling and stability by changing the tensile modulus of belt reinforcing layers in the tire width direction.

2. Description of the Prior Art

In order to increase the cornering stiffness and to improve handling and stability, some pneumatic tires are provided with belt reinforcing layers reinforced by placing reinforcing cords (made of organic fibers or steel) in the outer side of the tire radius direction of the belt layers (Patent Document 1: Unexamined Japanese Laid-Open Patent Publication No. 1-278802). In these tires, belt reinforcing layers composed of the reinforcing cord whose tensile modulus is large are employed or the number of the reinforcing cord per unit width is increased.

### SUMMARY OF THE INVENTION

In the above mentioned pneumatic tires, when the cornering stiffness increases, the tensile force on the belt reinforcing layer increases, however, the tensile force on the belt layer decreases by just that much. As a result, when the slip angle is large, the cornering force is lowered, which sometimes gives rise to the problem of degraded handling and stability.

Therefore, the object of the present invention is to provide a pneumatic tire with improved handling and stability without lowering the cornering force even when the slip angle is large.

The pneumatic tire of the present invention has characteristics in that it is the pneumatic tire provided with a pair of bead portions, one or more troidal shaped carcasses both ends of which wound up around the bead portions, one or more belt layers arranged in the outer side in the tire radius direction of the crown portion of the carcasses, one or more belt reinforcing layer arranged in the further outer side in the tire radius direction, and a tread rubber arranged in the further outer side in the tire radius direction, wherein, when W represents the width of the belt layer in the innermost side in the tire radius direction, A represents the region of the belt reinforcing layer which is the region at the both sides of the tire equator plane in the tire width direction, B represents the region in the outer side in the tire width direction of the region A, and C represents the region that is further outer side in the tire width direction of the region B, Wa that is the width of the region A is 2 to 10% of W, Wb that is the width of the region B is 15 to 40% of W, Mc that is the tensile modulus per inch (25.4 mm) of the belt reinforcing layer at the region C is 350 to 2000N, Ma that is the tensile modulus per inch of the belt reinforcing layer at the region A is 100 to 400% of Mc, Mb that is the tensile modulus per inch of the belt reinforcing layer at the region B is 200 to 800% of Mc, and Mb is larger than Ma.

By making Ma that is the tensile modulus at the region A in the width direction center of the belt reinforcing layer smaller than Mb that is the tensile modulus at the region B in the outer side of the width direction of the region A, the variation of the tire grounding pressure in the width direction becomes smaller. As a result, even when the slip angle is large, the cornering force is not lowered and handling and stability is improved.

### BRIEF DESCRIPTION OF THE DRAWINGS

FIG. 1 is a half-sectional view showing the pneumatic tire of the present invention.

FIG. 2 is a half-sectional view showing the pneumatic tire of the present invention.

### DESCRIPTION OF THE PREFERRED EMBODIMENTS

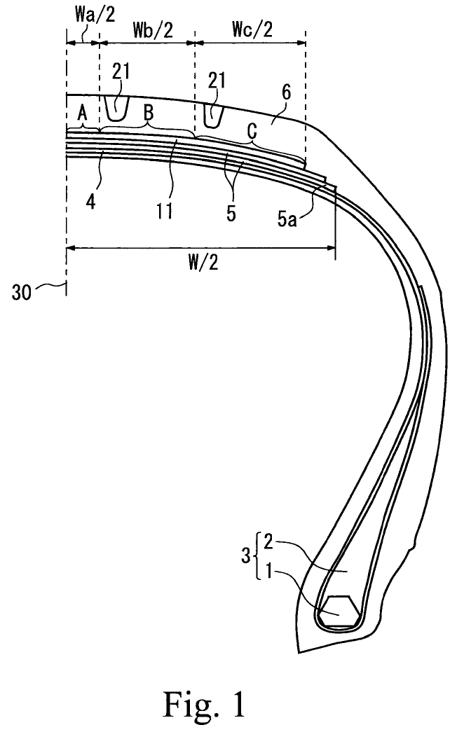

Hereinafter, explanation on embodiments for carrying out the pneumatic tire of the present invention is made using drawings. FIG. 1 is a right half-sectional view showing the pneumatic tire of the present invention. A bead portion 3 consisting of a bead core 1 and a bead filler 2 is wound up by an end portion of a carcass 4. The carcass 4 is troidal shaped and in the outer side in the tire radius direction of a crown portion of the carcass 4, two belt layers 5 are arranged. Further, in the outer side in the tire radius direction, a belt reinforcing layer 11 and a tread 6 are arranged. On the tread 6, main grooves 21 and transverse grooves (not illustrated) are formed. For information, one or more carcasses 4 and belt layers 5 may be used. In general, two belt layers 5 are arranged so that the steel cords extending obliquely in the tire circumferential direction of each belt layers 5 intersect each other.

Here, the definition is so made that W represents the width of the belt layer 5a in the innermost side in the radius direction, A represents the region of the belt reinforcing layer 11 which is the region at the both sides of the tire equator plane 30 in the tire width direction, B represents the region that is in the outer side in the tire width direction of the region A, and C represents the region that is in the further outer side in the tire width direction of the region B. And Mc that is the tensile modulus per inch (25.4 mm) of the belt reinforcing layer 11 at the region C is 350 to 2000N, Ma that is the tensile modulus per inch of the belt reinforcing layer 11 at the region A is 100 to 400% of Mc, Mb that is the tensile modulus per inch of the belt reinforcing layer 11 at the region B is 200 to 800% of Mc, and Mb is larger than Ma.

Regions A to C exist also on the left semi-sectional view of the tire (not illustrated) and the width Wa, Wb, and Wc is the width in the entire cross section of the tire. In addition, it is preferable that Wc that is the width of the region C is not less than 50% of W.

By making Ma that is the tensile modulus at the region A of the belt reinforcing layer 11 smaller than Mb that is the tensile modulus at the region B, the variation of the tire grounding pressure in the width direction becomes smaller. As a result, even when the slip angle is large, the cornering force is not lowered and handling and stability is improved.

When width Wa, Wb, and Wc or tensile modulus Ma, Mb, and Mc get out of the above mentioned range, and when the slip angle is large, the cornering force is sometimes lowered. For information, tensile modulus Ma, Mb, and Mc (unit: N/inch) is given by stress when extended by 2% to one reinforcing cord [N]×the number of the reinforcing cord [number/inch] per inch.

The belt reinforcing layer 11 is reinforced by the reinforcing cord (not illustrated) extending in the circumferential direction, however, the materials of the reinforcing cord are not specifically limited and nylon fibers, polyester fibers, polyethylene naphthalate fibers, aramid fibers, steel cords and the like can be used. For example, with nylon fibers, tensile modulus of 350 to 450 [N/inch], with polyester fibers, tensile modulus of 500 to 1000 [N/inch], with polyethylene naphthalate fibers, tensile modulus of 1000 to 2000 [N/inch], and with aramid fibers, tensile modulus of 2500 to 5000 [N/inch] can be realized.

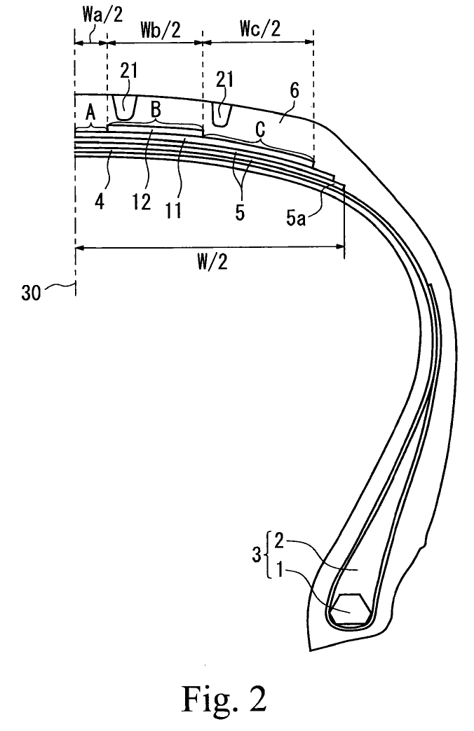

Methods of making the tensile modulus in each region differ are not specifically limited. For example, in the regions where the tensile modulus is heightened, it is enough to embed reinforcing cords with higher tensile modulus or to increase the number of the reinforcing cords per inch. Or as shown in FIG. 2, the method of adding the second reinforcing cord 12 is also available.

### EXAMPLE

Tires for Examples and those for Comparative Examples related to the present invention were manufactured and evaluation was made on each of them. The tires for Examples and those for Comparative Examples are the ones whose tensile modulus is different in the tire width direction and the tensile modulus per inch of the belt reinforcing layer of the tire of the conventional Example was 450N and the width was 104% of W that is the width of the belt layer. The size of each tire was 225/45R17 and it was installed on the rim whose size is 17×8-JJ and the evaluation was made under the air pressure of 220 kPa.

The tires of the Examples and those of the Comparative Examples were provided with a belt reinforcing layer that has the tensile modulus shown in Table 1. In the Examples and Comparative Examples, the materials of the reinforcing cord are chosen and the number of the reinforcing cord per inch of the reinforcing cord is appropriately changed, thereby changing the tensile modulus Ma, Mb, and Mc in each region. For information, the tensile modulus of the reinforcing cord was measured based on JIS L1017 by the tensile testing machine manufactured by Instron Japan Company Limited.

The cornering force was measured with the slip angle in the unit of one degree from 1 degree to 20 degrees by a flat belt cornering testing machine (speed 10 km/h, load 420 kg). Table 1 shows the cornering force when the slip angle is 1 degree, the maximum cornering force, and the slip angle when the maximum cornering force is generated. The cornering force is an index letting the value of the conventional Example as 100 and the larger numerical value shows the larger cornering force.

TABLE 1

| | | | | | | | | Con- | Com- | Com- | Com- | Com- |
|---|---|---|---|---|---|---|---|---|---|---|---|---|
| | | | | Ex- | Ex- | Ex- | Ex- | ventional | parative | parative | parative | parative |
| | | Example 1 | Example 2 | ample 3 | ample 4 | ample 5 | ample 6 | Example | Example 1 | Example 2 | Example 3 | Example 4 |
| Width of | Wₐ/W (%) | 5 | 2 | 10 | 2 | 5 | 5 | — | 1 | 11 | 11 | 1 |
| each | W_{b}/W (%) | 25 | 15 | 40 | 40 | 25 | 25 | — | 14 | 14 | 41 | 41 |
| region | W_{c}/W (%) | 74 | 87 | 54 | 62 | 74 | 74 | — | 89 | 79 | 52 | 62 |
| Tensile | Mₐ/M_{c} (%) | 200 | 100 | 400 | 100 | 200 | 200 | — | 90 | 410 | 410 | 90 |
| modulus of | M_{b}/M_{c} (%) | 500 | 200 | 800 | 800 | 500 | 500 | — | 190 | 190 | 810 | 810 |
| each | M_{c} (N/inch) | 450 | 450 | 450 | 450 | 350 | 2000 | — | 450 | 450 | 450 | 450 |
| region | | | | | | | | | | | | |

| | | | | | | | | | | | |
|---|---|---|---|---|---|---|---|---|---|---|---|
| Cornering force (slip | 104 | 101 | 106 | 105 | 101 | 110 | 100 | 101 | 104 | 106 | 105 |
| angle: 1 degree) | | | | | | | | | | | |
| Maximum cornering force | 107 | 101 | 100 | 100 | 108 | 100 | 100 | 99 | 97 | 99 | 99 |
| Slip angle when maximum | 12 | 13 | 12 | 13 | 13 | 12 | 13 | 13 | 12 | 12 | 12 |
| cornering force is | | | | | | | | | | | |
| generated (degree) | | | | | | | | | | | |

Width of the belt layer W: 200 mm

According to Table 1, the tires of the Examples could increase the cornering force in both cases when the slip angle is large and small.

What is claimed is:

1. A pneumatic tire provided with a pair of bead portions, one or more troidal shaped carcasses both ends of which wound up around the bead portions, one or more belt layers arranged in the outer side in the tire radius direction of the crown portion of the carcasses, one or more belt reinforcing layer arranged in the further outer side in the tire radius direction, and a tread rubber arranged in the further outer side in the tire radius direction, wherein, when W represents the width of the belt layer in the innermost side in the tire radius direction, A represents the region of the belt reinforcing layer which is the region at the both sides of the tire equator plane in the tire width direction, B represents the region in the outer side in the tire width direction of the region A, and C represents the region that is further outer side in the tire width direction of the region B, Wa that is the width of the region A is 2 to 10% of W, Wb that is the width of the region B is 15 to 40% of W, Mc that is the tensile modulus per inch (25.4 mm) of the belt reinforcing layer at the region C is 350 to 2000N, Ma that is the tensile modulus per inch of the belt reinforcing layer at the region A is 100 to 400% of Mc, Mb that is the tensile modulus per inch of the belt reinforcing layer at the region B is 200 to 800% of Mc, and Mb is larger than Ma.
